(19) United States
(12) Patent Application Publication
(10) Pub. No.: US 2014/0325689 A1
(43) Pub. Date: Oct. 30, 2014

(54) SHUTDOWN VERIFICATION METHOD AND DEVICE

(71) Applicant: TENCENT TECHNOLOGY (SHENZHEN) COMPANY LIMITED, Shenzhen City (CN)

(72) Inventors: YING-HUA YE, Shenzhen City (CN); YUE-JIAO HOU, Shenzhen City (CN)

(21) Appl. No.: 14/328,692

(22) Filed: Jul. 10, 2014

Related U.S. Application Data
(63) Continuation of application No. PCT/CN2014/074113, filed on Mar. 26, 2014.

(30) Foreign Application Priority Data
Apr. 26, 2013 (CN) 201310150018.5

(51) Int. Cl. G06F 21/88

(52) U.S. Cl. CPC G06F 21/88
USPC 726/35

(57) ABSTRACT

A shutdown verification method executed by a mobile terminal is provided. At first, a shutdown command is received. Then, a shutdown verification prompt which requests a verification input is output. After the verification input is received, the verification input is compared with preset verification data previously stored in the mobile terminal. At last, the mobile terminal is shut down if the verification input matches the preset verification data. A shutdown verification device corresponding to the shutdown verification method is also provided. The mobile terminal cannot be shut down without verification. Therefore, malicious shutdown of the mobile terminal is avoided.

### CROSS REFERENCE

The application is a U.S. continuation application under 35 U.S.C. §111(a) claiming priority under 35 U.S.C. §120 and §365(c) to International Application No. PCT/CN2014/074113 filed Mar. 26, 2014, which claims the priority benefit of CN patent application serial No. 201310150018.5, titled “shutdown verification method and device” and filed Apr. 26, 2013, the contents of which are incorporated by reference herein in their entirety for all intended purposes.

### FIELD OF THE TECHNOLOGY

The present disclosure relates to electronic technology, and more particularly to a shutdown verification method and device.

### BACKGROUND

With development of electronic technology, mobile terminals such as mobile phones and handheld computers are commonly used, especially for communication. The mobile terminals are usually small in size and light in weight, especially expensive. Hence, there are numerous thefts of mobile terminals recently. In a crowded place, for example market, bus and train, nobody can ensure that his mobile terminal is safe without theft risk.

When a user finds that his mobile terminal such as mobile phone is stolen, he likely borrows someone's mobile phone to call his own phone number to find where the ringing mobile phone is. However, if his mobile phone is shut down by the thief before the call, this method cannot work. Thus, the user loses his best chance to recover his mobile terminal.

Nowadays, many anti-theft applications for mobile terminals are proposed. For example, the lost mobile terminal may provide its current location to a designated host according to automatic positioning technology while being connected to a network. Therefore, the stolen mobile terminal can be tracked and monitored. Sometimes, if private information stored in the mobile terminal must not be revealed in any event, remote erase may be used to delete the information from the missing mobile terminal. However, if the mobile phone is shut down so that no connection can be established thereto, the above methods cannot work, either. Therefore, technical solutions for avoiding the malicious shutdown of the mobile terminals are required.

### SUMMARY

The present disclosure provides a shutdown verification method and a shutdown verification device to avoid malicious shutdown of mobile terminals.

An aspect of the present disclosure provides a shutdown verification method executed by a mobile terminal. At first, a shutdown command is received. Then, a shutdown verification prompt which requests a verification input is output. After the verification input is received, the verification input is compared with preset verification data previously stored in the mobile terminal. At last, the mobile terminal is shut down if the verification input matches the preset verification data.

Another aspect of the present disclosure provides a shutdown verification device of a mobile terminal. The shutdown verification device includes a command receiving unit, a prompting unit, a verification input receiving unit, a comparing unit, and a shutdown unit. The command receiving unit is configured to receive a shutdown command. The prompting unit is configured to output a shutdown verification prompt which requests a verification input after the command receiving unit receives the shutdown command. The verification input receiving unit receives the verification input, and the comparing unit compares the verification input with preset verification data previously stored in the mobile terminal. The shutdown unit is configured to shut down the mobile terminal if the verification input matches the preset verification data.

### BRIEF DESCRIPTION OF THE DRAWINGS

The present disclosure will become more readily apparent to those ordinarily skilled in the art after reviewing the following detailed description and accompanying drawings, in which:

FIG. 1 is a flow chart illustrating an embodiment of a shutdown verification method;

FIG. 2 and FIG. 3 are schematic diagrams illustrating prompts output on a mobile terminal according to the embodiment with reference to FIG. 1;

FIG. 4 is a flow chart illustrating another embodiment of a shutdown verification method;

FIG. 5 and FIG. 6 are schematic diagrams illustrating prompts shown on a mobile terminal according to the embodiment with reference to FIG. 4;

FIG. 7 is a schematic diagram illustrating an embodiment of a shutdown verification device; and

FIG. 8 is a schematic diagram illustrating another embodiment of a shutdown verification device.

### DETAILED DESCRIPTION OF PREFERRED EMBODIMENTS

The present disclosure will now be described more specifically with reference to the following embodiments. It is to be noted that the following descriptions of embodiments of this invention are presented herein for purpose of illustration and description only. It is not intended to be exhaustive or to be limited to the precise form disclosed.

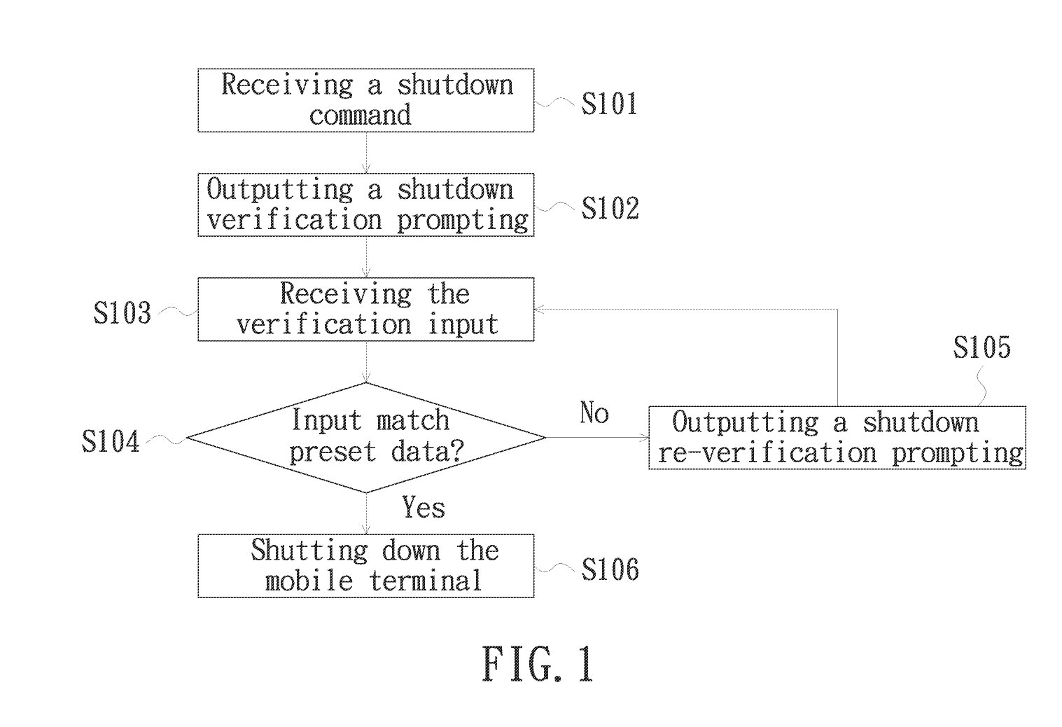

The present application relates to a shutdown verification method. Please refer to FIG. 1, a flow chart illustrating an embodiment of a shutdown verification method. The shutdown verification method is executed by a mobile terminal. The steps are described in detail as follows.

In step S101, a shutdown command generated in response to a user operation is received.

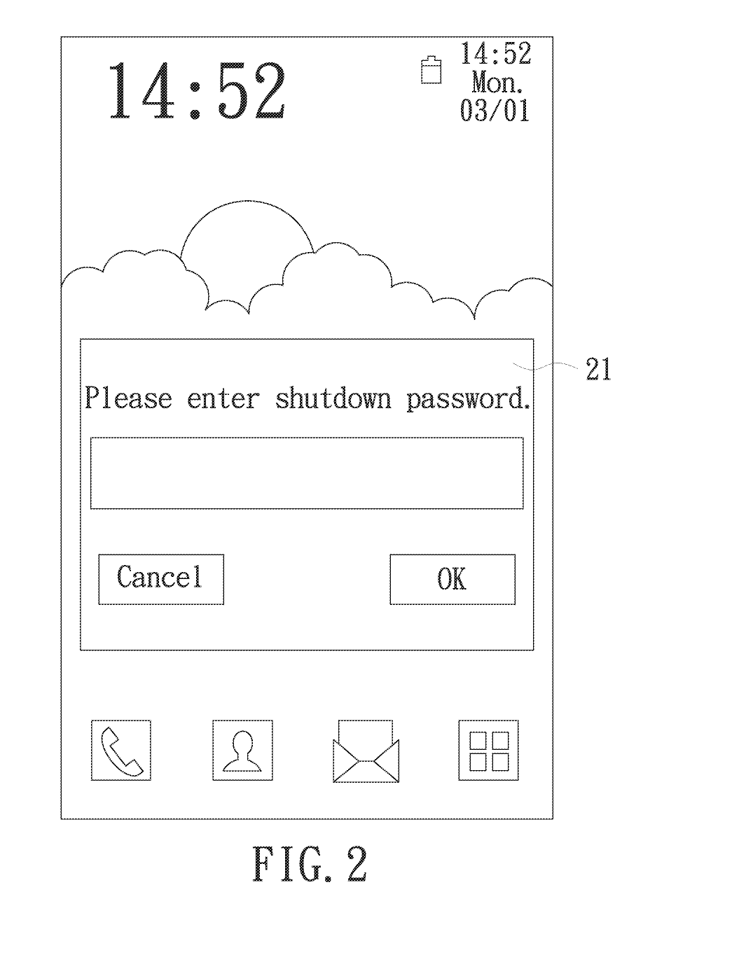

In step S102, a shutdown verification prompt which requests a verification input is output. The shutdown verification prompt may be a prompt window output on a display unit of the mobile terminal. For example, FIG. 2 illustrates the prompt window 21 for shutdown password input. Otherwise, the shutdown verification prompt may request input for fingerprint verification, speech (voice) verification, facial recognition based on facial features in a face image captured by a camera of the mobile terminal, or other possible biometric verification. In another application, the shutdown verification prompt may prompt the user to answer a preset question.

In step S103, the verification input is received. The verification input may be at least one of a password consisting of numbers and/or characters, a voice input, a fingerprint input, a face image input, and other input corresponding to the verification type indicated in step S102.

In step S104, the verification input is compared with preset verification data. The preset verification data is previously stored on a back-end of the mobile terminal. After the user provides or enters the verification input, the verification input is compared with the preset verification data. If the verification input matches the preset verification data, the method is directed to step S106. Otherwise, if the verification input does not match the preset verification data, i.e. match failure, the method is directed to step S105.

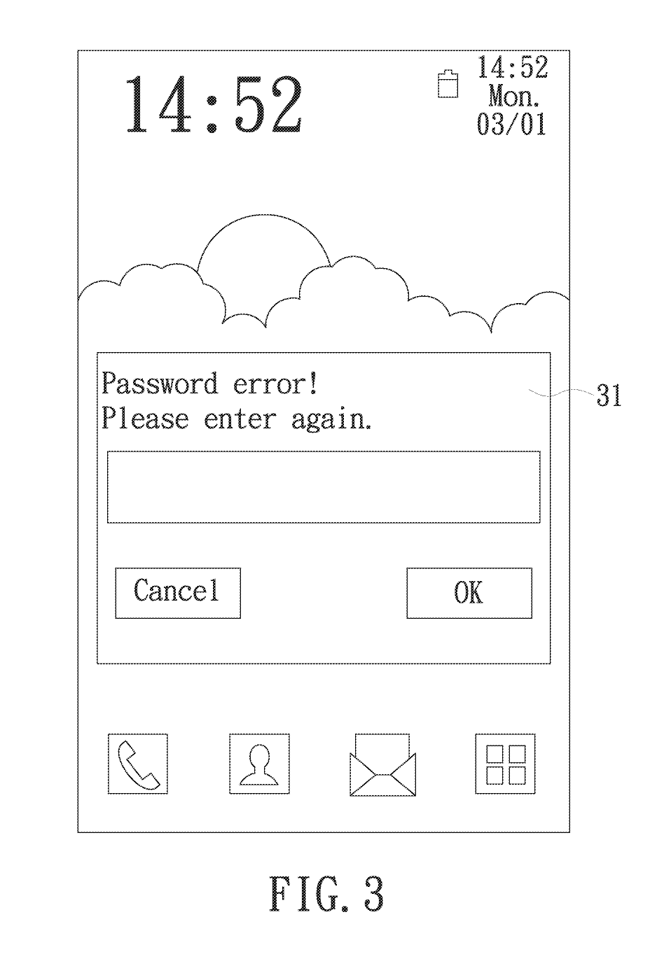

In step S105, a shutdown re-verification prompt which requests a new verification input is output. For example, FIG. 3 illustrates the prompt window 31 which indicates password error and requests another shutdown password input. Then, the method is directed to step S103 for another comparison.

In step S106, the mobile terminal is shut down as requested by the user in step S101.

By this shutdown verification method, the mobile terminal cannot be arbitrarily shut down without verification. Therefore, malicious shutdown of the mobile terminal is avoided so as to increase possibility of recovery of the lost mobile terminal

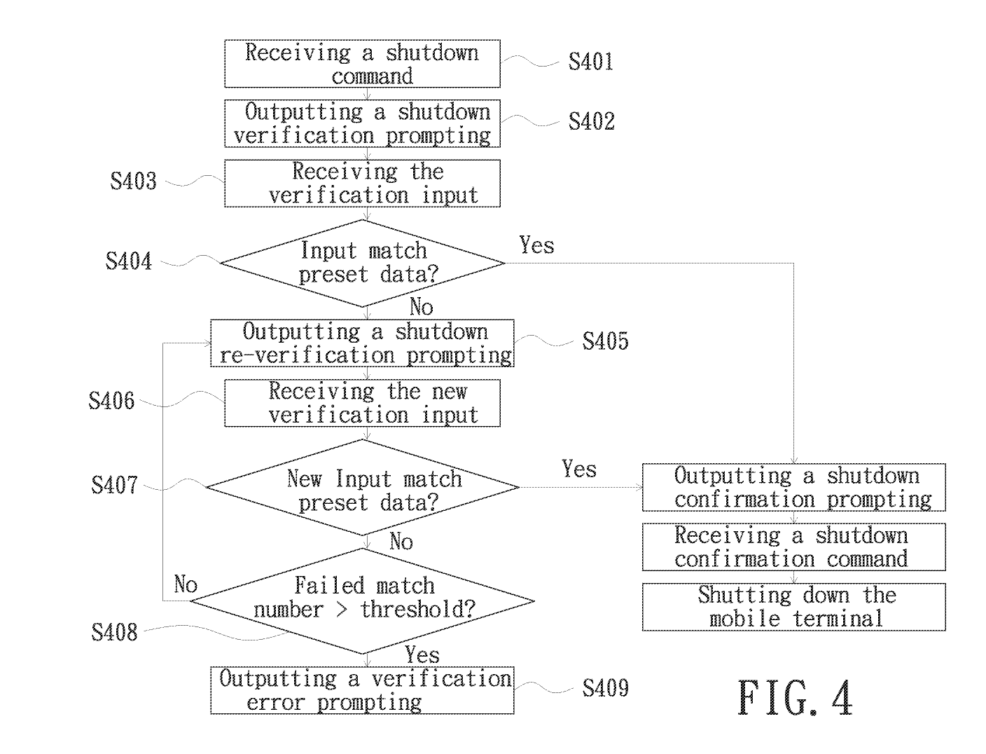

Please refer to FIG. 4, a flow chart illustrating another embodiment of a shutdown verification method. The shutdown verification method is executed by a mobile terminal. The steps are described in detail as follows.

In step S401, a shutdown command generated in response to a user operation is received.

In step S402, a shutdown verification prompt which requests a verification input is output. The shutdown verification prompt may be a prompt window output on a display unit of the mobile terminal. For example, the shutdown verification prompt may request various input for password verification, fingerprint verification, speech (voice) verification, facial recognition, or other possible biometric verification. In another application, the shutdown verification prompt may prompt the user to answer a preset question.

In step S403, the verification input is received. The verification input may be at least one of a password consisting of numbers and/or characters, a voice input, a fingerprint input, a face image or other input corresponding to the verification type indicated in step S402.

In step S404, the verification input is compared with preset verification data. The preset verification data is previously stored on a back-end of the mobile terminal. After the user provides or enters the verification input, the verification input is compared with the preset verification data. If the verification input matches the preset verification data, the method is directed to step S410. Otherwise, if the verification input does not match the preset verification data, i.e. match failure, the method is directed to step S405.

In step S405, a shutdown re-verification prompt which requests a new verification input is output on the display unit if the previous verification input does not match the preset verification data.

In step S406, the new verification input is received.

In step S407, the new verification input is compared with the preset verification data. If the new verification input matches the preset verification data, the method is directed to step S410. Otherwise, if the new verification input does not match the preset verification data, i.e. match failure, the method is directed to step S408.

In step S408, the mobile terminal determines whether a number of successive failed match is greater than a threshold. If the number is greater than the threshold, the method is directed to step S409. Otherwise, if the number is not greater than the threshold, the method goes back to step S405 to request another verification input. For example, the threshold is three times.

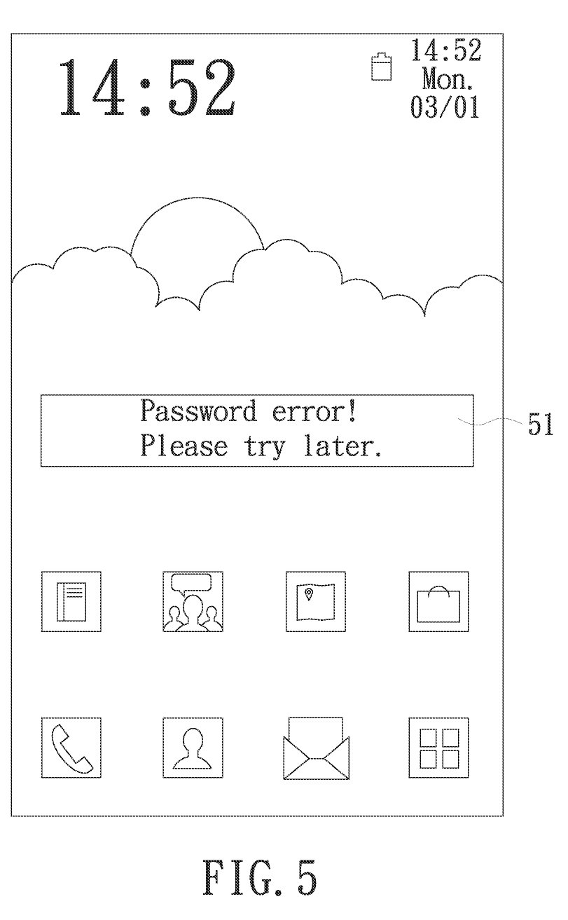

In step S409, a verification error prompt is output on the display unit. For example, FIG. 5 illustrates a prompt box 51 which indicates password error and prompts the user to try shutdown later. Then, the prompt box 51 is closed to return the mobile terminal to desktop display.

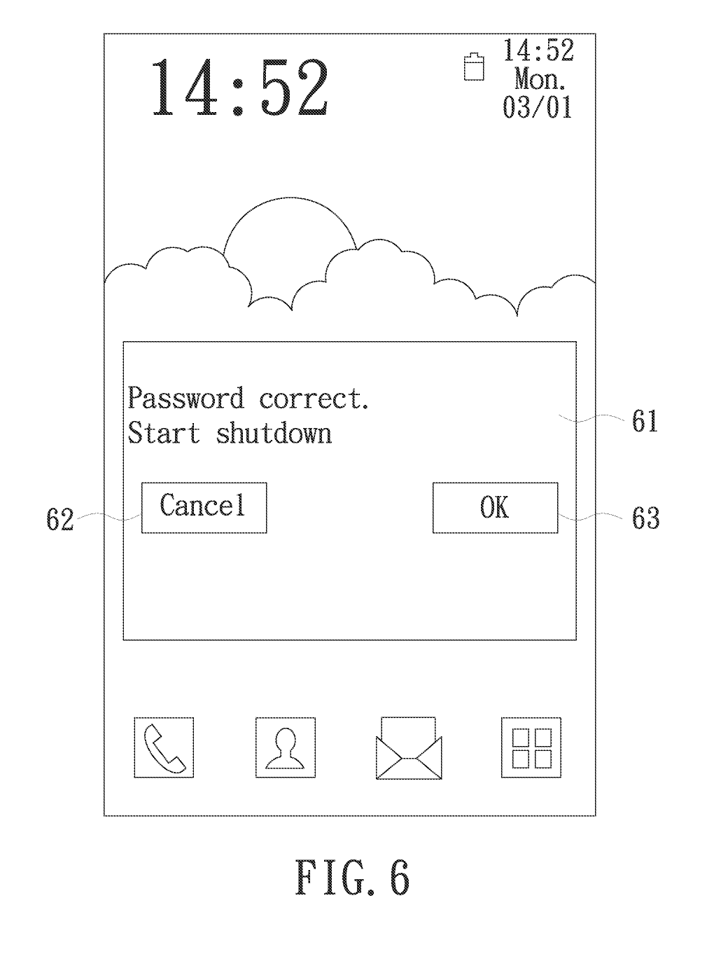

In step S410, a shutdown confirmation prompt which requests a shutdown confirmation operation is output on the display unit. For example, FIG. 6 illustrates a prompt box 61 which indicates password correct and asks for shutdown confirmation operation. The user may choose a cancel button 62 to cancel shutdown procedure or an OK button 63 to send a shutdown confirmation command to start shutdown procedure.

In step S411, the shutdown confirmation command is received.

In step S412, the mobile terminal is shut down, as requested by the user in step S401.

By this shutdown verification method, the mobile terminal cannot be arbitrarily shut down without verification. Therefore, malicious shutdown of the mobile terminal is avoided so as to increase possibility of recovery of the lost mobile terminal with anti-theft effect.

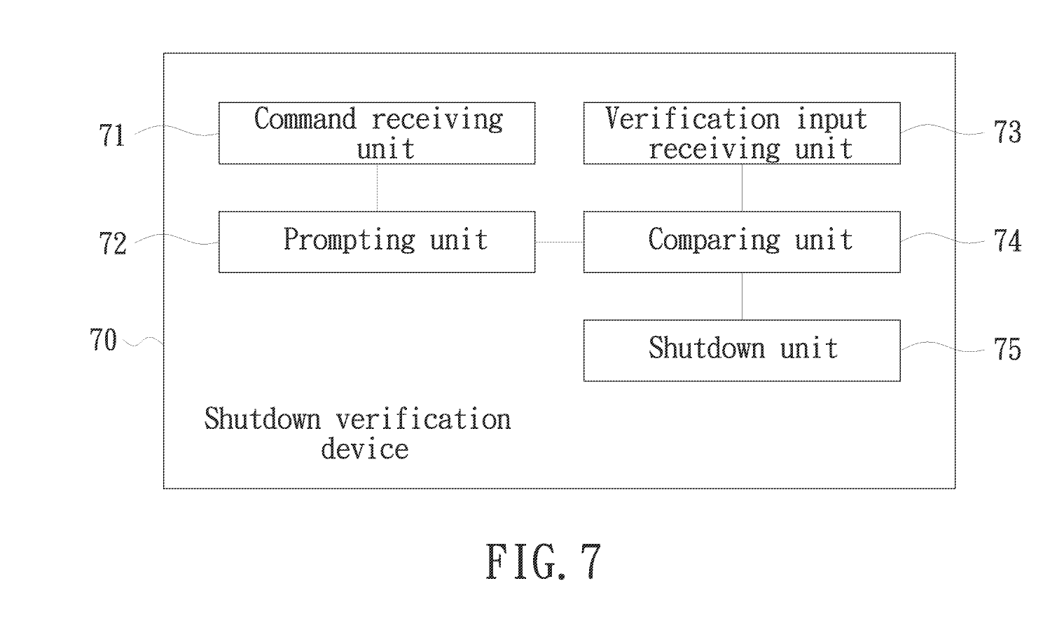

The present application also relates to a shutdown verification device. Please refer to FIG. 7, a schematic diagram illustrating an embodiment of a shutdown verification device. The shutdown verification device 70 is embedded or integrated in a mobile terminal. The shutdown verification device 70 includes a command receiving unit 71, a prompting unit 72, a verification input receiving unit 73, a comparing unit 74 and a shutdown unit 75. The prompting unit 72 is in communication with the command receiving unit 71. The comparing unit 74 is in communication with the prompting unit 72 and the verification input receiving unit 73. The shutdown unit 75 is in communication with the comparing unit 74.

The command receiving unit 71 is configured to receive a shutdown command generated in response to a user operation. After the command receiving unit 71 receives the shutdown command, the prompting unit 72 displays a shutdown verification prompt which requests a verification input. The shutdown verification prompt may be a prompt window output on a display unit (not shown) of the mobile terminal. For example, the shutdown verification prompt may request various input for password verification, fingerprint verification, speech (voice) verification, facial recognition, or other possible biometric verification. In another application, the shutdown verification prompt may prompt the user to answer a preset question.

The verification input receiving unit 73 is configured to receive the verification input. The verification input may be a password consisting of numbers and/or characters, a voice input, a fingerprint input or other input corresponding to the verification type mentioned above. After the verification input receiving unit 73 receives the verification input, the comparing unit 74 compares the verification input with preset verification data previously stored on a back-end of the mobile terminal. If the verification input matches the preset verification data, the shutdown unit 75 shuts down the mobile terminal. Otherwise, if the verification input does not match the preset verification data, i.e. match failure, the prompting unit 72 displays a shutdown re-verification prompt which requests a new verification input to be received by the verification input receiving unit 73 and compared by the comparing unit 74.

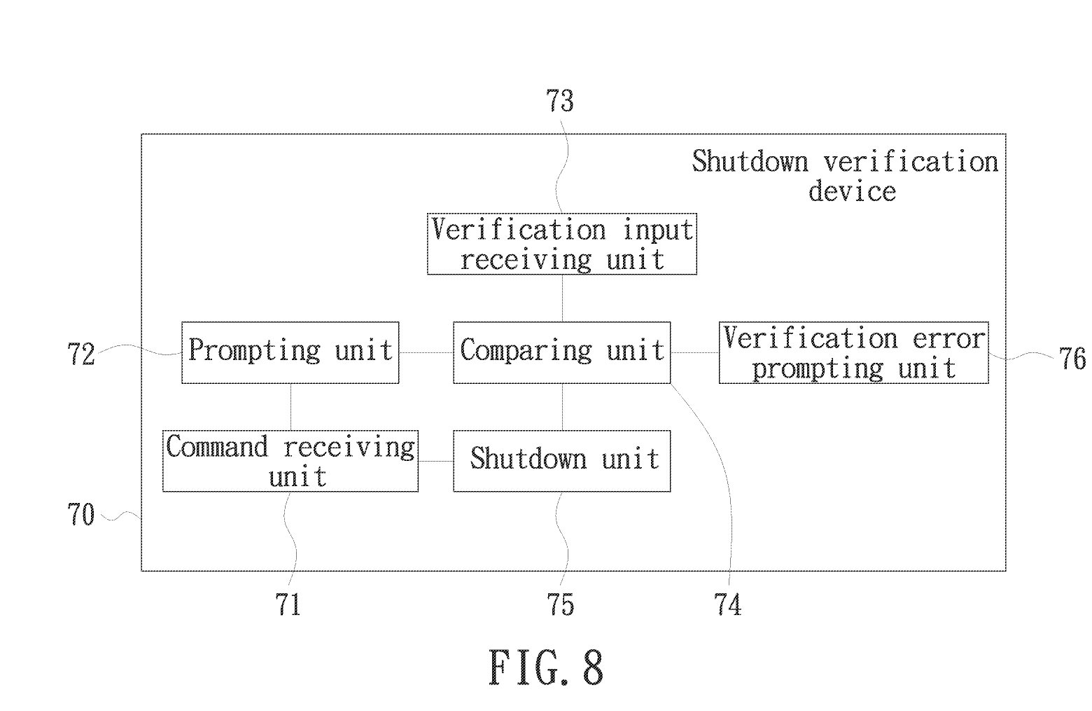

Please refer to FIG. 8, a schematic diagram illustrating another embodiment of a shutdown verification device. The shutdown verification device 70 is embedded or integrated in a mobile terminal. In addition to the command receiving unit 71, the prompting unit 72, the verification input receiving unit 73, the comparing unit 74, and the shutdown unit 75, the shutdown verification device 70 further includes a verification error prompting unit 76. The prompting unit 72 is in communication with the command receiving unit 71. The comparing unit 74 is in communication with the prompting unit 72 and the verification input receiving unit 73. The shutdown unit 75 is in communication with the command receiving unit 71 and the comparing unit 74. The verification error prompting unit 76 is in communication with the comparing unit 74.

The command receiving unit 71 is configured to receive a shutdown command generated in response to a user operation. After the command receiving unit 71 receives the shutdown command, the prompting unit 72 displays a shutdown verification prompt which requests a verification input. The shutdown verification prompt may be a prompt window output on a display unit (not shown) of the mobile terminal. For example, the shutdown verification prompt may request various input for password verification, fingerprint verification, speech (voice) verification, facial recognition, or other possible biometric verification. In another application, the shutdown verification prompt may prompt the user to answer a preset question.

The verification input receiving unit 73 is configured to receive the verification input. The verification input may be a password consisting of numbers and/or characters, a voice input, a fingerprint input or other input corresponding to the verification type mentioned above. After the verification input receiving unit 73 receives the verification input, the comparing unit 74 compares the verification input with preset verification data previously stored on a back-end of the mobile terminal. If the comparing unit 74 determines that the verification input matches the preset verification data, the prompting unit 72 outputs a shutdown confirmation prompt which requests a shutdown confirmation operation on the display unit. After the command receiving unit 71 receives a shutdown confirmation command generated in response to the shutdown confirmation operation, the shutdown unit 75 shuts down the mobile terminal. Otherwise, if the comparing unit 74 determines that the verification input does not match the preset verification data, i.e. match failure, the prompting unit 72 outputs a shutdown re-verification prompt which requests a new verification input to be received by the verification input receiving unit 73 and compared by the comparing unit 74.

If a number of successive failed match at the comparing unit 74 is greater than a threshold, the verification error prompting unit 76 outputs a verification error prompt on the display unit. For example, the threshold is three times.

By this shutdown verification device, the mobile terminal cannot be arbitrarily shut down without verification. Therefore, malicious shutdown of the mobile terminal is avoided so as to increase possibility of recovery of the lost mobile terminal with anti-theft effect.

It is to be noted that the mobile terminal in the embodiments of the invention may be a mobile phone or other electronic devices with communication function. As used in this specification and any claims of this application, the terms “terminal” and “display unit” refer to electronic devices. These terms exclude people or groups of people.

For those having ordinary skill in the art, it is understood that all or part of the steps in the various embodiments described above can be executed by hardware or programs, and the corresponding program may be stored in a computer readable storage medium. The so-called storage medium can be, for example, a ROM/RAM, disk or optical disk, etc.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shutdown verification method executed by a mobile terminal, comprising the steps of:
receiving a shutdown command;
outputting, according to the shutdown command, a shutdown verification prompt which requests a verification input;
receiving the verification input;
comparing the verification input with preset verification data previously stored in the mobile terminal; and
shutting down the mobile terminal if the verification input matches the preset verification data.

2. The shutdown verification method according to claim 1, after the step of comparing the verification input with preset verification data previously stored in the mobile terminal, further comprising: outputting a shutdown re-verification prompt which requests a new verification input if the verification input does not match the preset verification data.

3. The shutdown verification method according to claim 2, after the step of outputting a shutdown re-verification prompt which requests a new verification input further comprising:
receiving the new verification input;
comparing the new verification input with the preset verification data;
determining whether a number of successive failed match is greater than a threshold if the new verification input does not match the preset verification data; and
outputting a verification error prompt if the number is greater than the threshold.

4. The shutdown verification method according to claim 3, wherein the threshold is three times.

5. The shutdown verification method according to claim 1, wherein the step of shutting down the mobile terminal if the verification input matches the preset verification data further comprises:
outputting a shutdown confirmation prompt which requests a shutdown confirmation operation;
receiving a shutdown confirmation command in response to the shutdown confirmation operation; and
shutting down the mobile terminal.

6. The shutdown verification method according to claim 1, wherein the verification input is selected from the group consisting of: a password, a voice input, a fingerprint input, a face image input, and a combination thereof.

7. The shutdown verification method according to claim 2, wherein the verification input is selected from the group consisting of: a password, a voice input, a fingerprint input, a face image input, and a combination thereof.

8. The shutdown verification method according to claim 3, wherein the verification input is selected from the group consisting of: a password, a voice input, a fingerprint input, a face image input, and a combination thereof.

9. The shutdown verification method according to claim 4, wherein the verification input is selected from the group consisting of: a password, a voice input, a fingerprint input, a face image input, and a combination thereof.

10. The shutdown verification method according to claim 5, wherein the verification input is selected from the group consisting of: a password, a voice input, a fingerprint input, a face image input, and a combination thereof.

11. A shutdown verification device of a mobile terminal, comprising:
a command receiving unit configured to receive a shutdown command;
a prompting unit configured to output a shutdown verification prompt which requests a verification input after the command receiving unit receives the shutdown command;
a verification input receiving unit configured to receive the verification input;
a comparing unit configured to compare the verification input with preset verification data previously stored in the mobile terminal; and
a shutdown unit configured to shut down the mobile terminal if the verification input matches the preset verification data.

12. The shutdown verification device according to claim 11, wherein the prompting unit displays a shutdown re-verification prompt which requests a new verification input if the comparing unit determines that the verification input does not match the preset verification data.

13. The shutdown verification device according to claim 12, further comprising: a verification error prompting unit configured to output a verification error prompt if a number of successive failed match at the comparing unit is greater than the threshold.

14. The shutdown verification device according to claim 13, wherein the threshold is three times.

15. The shutdown verification device according to claim 11, wherein the prompting unit outputs a shutdown confirmation prompt which requests a shutdown confirmation operation if the comparing unit determines that the verification input matches the preset verification data, and the shutdown unit shuts down the mobile terminal after the command receiving unit receives a shutdown confirmation command generated in response to the shutdown confirmation operation.

16. The shutdown verification device according to claim 11, wherein the verification input is selected from the group consisting of: a password, a voice input, a fingerprint input, a face image input, and a combination thereof.

17. The shutdown verification device according to claim 12, wherein the verification input is selected from the group consisting of: a password, a voice input, a fingerprint input, a face image input, and a combination thereof.

18. The shutdown verification device according to claim 13, wherein the verification input is selected from the group consisting of: a password, a voice input, a fingerprint input, a face image input, and a combination thereof.

19. The shutdown verification device according to claim 14, wherein the verification input is selected from the group consisting of: a password, a voice input, a fingerprint input, a face image input, and a combination thereof.

20. A non-transitory computer-readable storage medium having instructions stored thereon, wherein the instructions, when executed by one or more processors, cause the one or more processors to perform operations comprising:
receiving a shutdown command;
outputting, according to the shutdown command, a shutdown verification prompt which requests a verification input;
receiving the verification input;
comparing the verification input with preset verification data previously stored in the mobile terminal; and
shutting down the mobile terminal if the verification input matches the preset verification data.
